(19) United States
(12) Patent Application Publication
(10) Pub. No.: US 2026/0288037 A1
(43) Pub. Date: Sep. 24, 2026

(54) IMAGE FORMING APPARATUS

(71) Applicants: Junya SAKURABA, Kanagawa (JP); Kunihiro KOMAI, Kanagawa (JP); Masaharu YOKONO, Kanagawa (JP); Masahiko HISADA, Kanagawa (JP); Naoya HIRAYAMA, Miyagi (JP)

(72) Inventors: Junya SAKURABA, Kanagawa (JP); Kunihiro KOMAI, Kanagawa (JP); Masaharu YOKONO, Kanagawa (JP); Masahiko HISADA, Kanagawa (JP); Naoya HIRAYAMA, Miyagi (JP)

(73) Assignee: Ricoh Company, Ltd., Tokyo (JP)

(21) Appl. No.: 19/538,211

(22) Filed: Feb. 12, 2026

(30) Foreign Application Priority Data
Mar. 18, 2025 (JP) 2025-043857

(51) Int. Cl. G03G 15/16; G03G 15/00; G03G 15/01

(52) U.S. Cl. CPC G03G 15/161; G03G 15/0131; G03G 15/0189; G03G 15/50; G03G 15/55

(57) ABSTRACT

An image forming apparatus includes an image former, a voltage applier, a separator, and circuitry. The transfer device transfers the toner image from the image former onto the transfer belt using the transfer roller. The voltage applier applies a voltage to the transfer roller. The separator separates the transfer device from the image former. The circuitry is configured to determine whether the voltage applied to the transfer roller is greater than or equal to a predetermined threshold. The circuitry is further configured to, in response to a determination that the voltage is greater than or equal to the threshold value, control the separator to separate the transfer device from the image former; and drive the transfer belt to rotate in a forward direction or a backward direction to perform a foreign-matter removal operation.

### CROSS-REFERENCE TO RELATED APPLICATIONS

This patent application is based on and claims priority pursuant to 35 U.S.C. § 119(a) to Japanese Patent Application No. 2025-043857, filed on Mar. 18, 2025, in the Japan Patent Office, the entire disclosure of which is hereby incorporated by reference herein.

### BACKGROUND

### Technical Field

The present disclosure relates to an image forming apparatus.

### Related Art

In electrophotographic image forming devices, a technology has been developed that detects an overcurrent in rollers and belts constituting a transfer unit and stops printing.

### SUMMARY

The present disclosure described herein provides an image forming apparatus includes an image former, a transfer device, a voltage applier, a separator, and circuitry. The image former forms a toner image. The transfer device includes a transfer belt and a transfer roller facing the image former with the transfer belt between the transfer roller and the image former, to transfer the toner image from the image former onto the transfer belt using the transfer roller. The voltage applier applies a voltage to the transfer roller. The separator separates the transfer device from the image former. The circuitry determines whether the voltage applied to the transfer roller is greater than or equal to a predetermined threshold. In response to a determination that the voltage is greater than or equal to the threshold value, the circuitry further controls the separator to separate the transfer device from the image former and drives the transfer belt to rotate in a forward direction or a backward direction to perform a foreign-matter removal operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an imager of a typical image forming apparatus according to a reference embodiment;

FIG. 2 is a schematic diagram of an imager of an image forming apparatus according to an embodiment of the present disclosure;

FIG. 3 is a functional block diagram of a controller in FIG. 2;

FIG. 4 is a flowchart of a control process for avoiding a high-voltage output abnormality; and

FIG. 5 is a hardware block diagram of a controller.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, downtime when an overcurrent is detected due to intrusion of a foreign matter into a transfer unit can be reduced.

Embodiments of the present disclosure are described below with reference to the accompanying drawings. In order to facilitate the understanding of the description, like reference signs denote like elements in the drawings, and overlapping description may be simplified or omitted as appropriate.

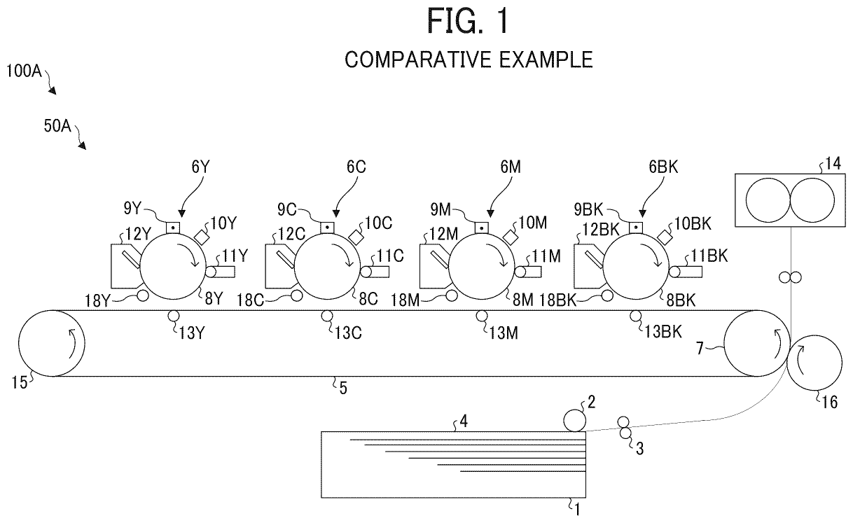

Referring now to FIG. 1, a description is given of a typical configuration of an imager 50A in an image forming apparatus 100. FIG. 1 is a schematic diagram of the imager 50A of a typical image forming apparatus 100A according to a reference embodiment.

In the image forming apparatus 100A according to a reference embodiment illustrated in FIG. 1, the imager 50A is a tandem-type image forming apparatus and includes image formers 6BK, 6C, 6M, and 6Y for respective colors of yellow (Y), magenta (M), cyan (C), and black (K), arranged along an intermediate transfer belt 5. That is, along the intermediate transfer belt 5, multiple image formers 6BK, 6M, 6C, and 6Y are arranged in this order from an upstream side of the intermediate transfer belt 5 in a traveling direction of the intermediate transfer belt 5. The image formers 6BK, 6M, 6C, and 6Y have a similar configuration except the color of toner images. The image former 6BK forms black toner images, the image former 6M forms magenta toner images, the image former 6C forms cyan toner images, and the image former 6Y forms yellow toner images. In the following description, the image former 6BK will be described in detail. The other image formers 6M, 6C, and 6Y have the same configuration as the image former 6BK. Accordingly, constituent elements of the image formers 6M, 6C, and 6Y are indicated in the drawings merely by reference numerals distinguished by suffixes M, C, and Y, and description thereof will be omitted.

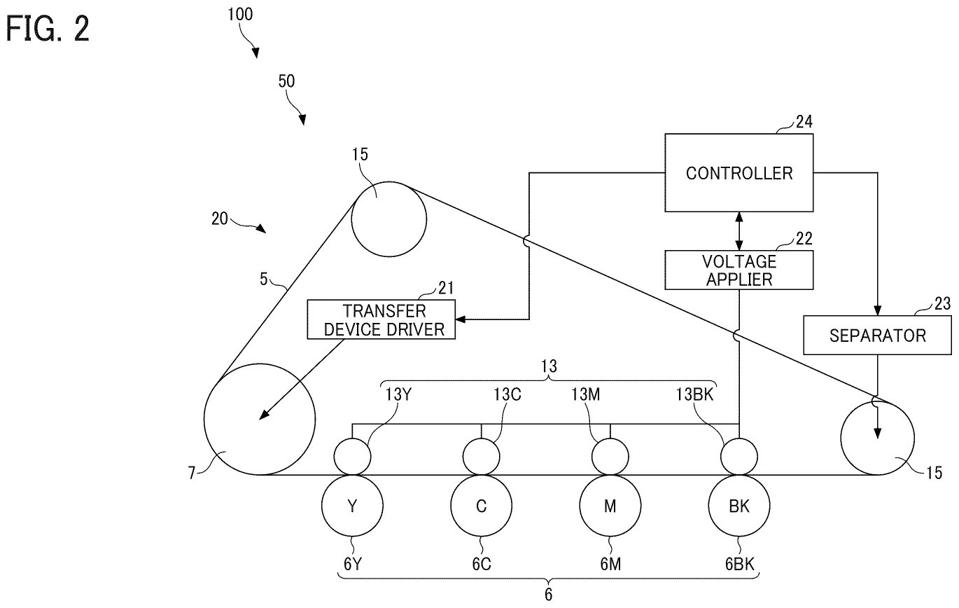

The intermediate transfer belt 5 is an endless belt looped around a drive roller 7 and a driven roller 15. The driving roller 7 is rotationally driven by a transfer-device driver 21 (see FIG. 2), such as a driving motor. The driving motor, the driving roller 7, and the driven roller 15 function together to move the intermediate transfer belt 5.

The image former 6BK includes a photoconductor drum 8BK serving as a photoconductor, and a charger 9BK, a light-emitting diode (LED) head 10BK, a developing device 11BK, a photoconductor cleaner 18BK, and a discharger 12BK, which are disposed around the photoconductor drum 8BK. The LED head 10BK emits light corresponding to the color of an image formed by each of the image formers 6BK, 6M, 6C, and 6Y. Each of a photoconductor cleaner 18Y, a photoconductor cleaner 18C, and a photoconductor cleaner 18M has the same configuration as the photoconductor cleaner 18BK. Each of a discharger 12Y, a photoconductor cleaner 12C, and a discharger 12M has the same configuration as the discharger 12BK. discharger. Each of a developing device 11Y, a developing device 11C, and a developing device 11M has the same configuration as the developing device 11BK. Each of a LED head 10Y, a LED head 10C, and a LED head 10M has the same configuration as the LED head 10BK. Each of a charger 9Y, a charger 9C, and a charger 9M has the same configuration as the charger 9BK.

During image formation, an outer circumferential surface of the photoconductor drum 8BK is uniformly charged by the charger 9BK in the dark. The outer circumferential surface of the photoconductor drum 8BK is then exposed to light emitted from the LED head 10BK and corresponding to a black image, thus forming an electrostatic latent image. The developing device 11BK develops the electrostatic latent image into a visible image with black toner. Thus, a black toner image is formed on the photoconductor drum 8BK. The toner image is transferred onto the intermediate transfer belt 5 at a contact position between the photoconductor drum 8BK and the intermediate transfer belt 5, by a bias applied to a primary transfer roller 13BK. After transfer of the toner image is completed, residual toner remaining on an outer circumferential surface of the photoconductor drum 8BK is removed by the photoconductor cleaner 18BK. Electric charges remaining on the outer circumferential surface of the photoconductor drum 8BK are then eliminated by the discharger 12BK. The photoconductor cleaner 18BK then stands by for a next image forming operation.

The intermediate transfer belt 5 moves to the next image former 6M in order to form the next image on the intermediate transfer belt 5 The image former 6M forms a magenta toner image on the photoconductor drum 8M through the processes similar to the processes performed by the image former 6BK. The magenta toner image is transferred from the photoconductor drum 8M and superimposed on the black toner image formed on the intermediate transfer belt 5.

The intermediate transfer belt 5 then moves to the subsequent image formers 6C and 6Y. By the same operation, a cyan toner image formed on the photoconductor drum 8C and a yellow toner image formed on the photoconductor drum 8Y are transferred onto the intermediate transfer belt 5 in an overlapped manner. Thus, a full-color image is formed on the intermediate transfer belt 5.

A sheet 4 separated and fed from a sheet feeding tray 1 by a sheet feeding roller 2 and a separation roller 3 is conveyed to a contact portion between the intermediate transfer belt 5 and the sheet 4. At the contact portion, a bias applied to a secondary transfer roller 16 transfers a full-color toner image on the intermediate transfer belt 5 onto the sheet 4, forming a full-color toner image on the sheet 4. The sheet 4 on which the full-color overlaid image is formed is conveyed to the fixing device 14, where the image is fixed, and is then discharged to an outside of the image forming apparatus 100A.

A bias is supplied from a high-voltage power supply (e.g., the voltage applier 22 in FIG. 2) to the charger 9, the developing device 11, the primary transfer roller 13, and the secondary transfer roller 16.

An image forming apparatus 100 according to an embodiment of the present disclosure is described below with reference to FIGS. 2 to 5.

FIG. 2 is a diagram illustrating the schematic configuration of an imager 50 in the image forming apparatus 100. In the following description, the image formers 6BK, 6M, 6C, and 6Y may be collectively referred to as an image former 6. Similarly, primary transfer rollers 13BK, 13M, 13C, and 13Y for the colors may collectively be referred to as a transfer roller 13.

As illustrated in FIG. 2, in the present embodiment, the transfer belt 5, a drive roller 7, a driven roller 15, and a transfer roller 13 of the imager 50 are collectively referred to as a transfer unit 20 (or a transfer device). That is, the transfer unit 20 includes the transfer belt 5 and the transfer roller 13, and transfers a toner image formed by the image former 6 onto the transfer belt 5 using the transfer roller 13. The transfer unit 20 is installed to be integrally movable by a separator 23 to be described later.

The imager 50 of the image forming apparatus 100 further includes a transfer-device driver 21, a voltage applier 22, a separator 23, and a controller 24.

The transfer-device driver 21 applies a driving force to the drive roller 7 of the transfer unit 20 to rotate the drive roller 7, driving the transfer belt 5. Any element that can generate a driving force, such as a motor, is applicable as the transfer-device driver 21.

The voltage applier 22 applies a voltage to the transfer roller 13.

The separator 23 separates the transfer unit 20 from the image former 6. In the configuration as illustrated in FIG. 2, the separator 23 moves the transfer unit 20 upward in FIG. 2 to separate the transfer unit 20 from the image former 6. The separator 23 includes a driving source, a guiding element, and other components to implement such an operation.

The controller 24 controls the operation of the imager 50. In the present embodiment, the controller 24 controls the operation of the transfer-device driver 21 to control the operation of the transfer belt 5 (e.g., a foreign matter removal operation described later). In the present embodiment, the controller 24 controls the operation of the voltage applier 22 to control a voltage level applied to the transfer roller 13. In the present embodiment, the controller 24 controls a transition between a separated state and a contact state of the transfer unit 20 with respect to the image former 6

Specifically in the present embodiment, upon determining, based on a detection signal of a high-voltage output transmitted from the voltage applier 22, that a high-voltage output abnormality has occurred, the controller 24 controls the separator 23 to separate the transfer unit 20 from the image former 6, and then controls the transfer-device driver 21 to rotate the transfer belt 5 forward or backward to perform a foreign-matter removal operation.

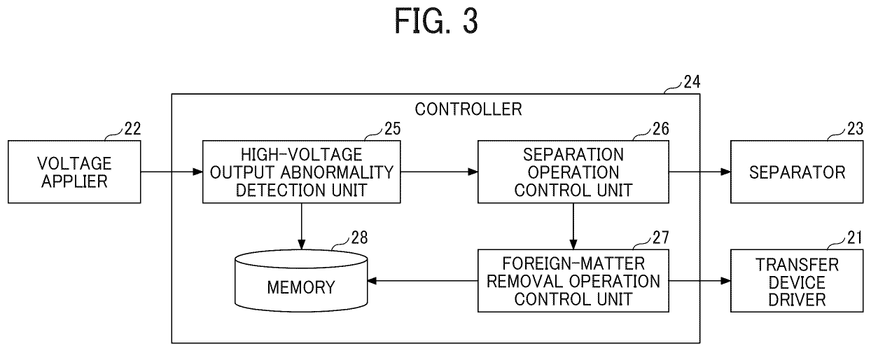

FIG. 3 is a functional block diagram of the controller 24 in FIG. 2. As illustrated in FIG. 3, the controller 24 includes a high-voltage output abnormality detection unit 25, a separation operation control unit 26, a foreign-matter removal operation control unit 27, and a memory 28 for operations performed upon detection of a high-voltage output abnormality.

The voltage applier 22 monitors a voltage value applied to the transfer roller 13, detects a high-voltage output abnormality when the voltage value becomes greater than or equal to a predetermined threshold, and transmits a detection signal thereof to the controller 24. The controller 24 (specifically, the high-voltage output abnormality detection unit 25) determines whether a high-voltage output abnormality has occurred based on the detection signal. When the controller 24 determines that a high-voltage output abnormality has occurred, the high-voltage output abnormality detection unit 25 outputs information indicating the detection to the separation operation control unit 26 and the memory 28.

When the voltage applier 22 detects a high-voltage output abnormality in the voltage applied to the transfer roller 13, the voltage applier 22 transmits a detection signal to the controller 24. Based on the detection signal, when the controller 24 determines that a high-voltage output abnormality has occurred, the separation operation control unit 26 controls the separator 23 to separate the transfer unit 20 from the image former 6. When the separation operation control unit 26 performs the separation operation, the separation operation control unit 26 outputs information indicating that the separation operation has been performed to the foreign-matter removal operation control unit 27.

When the separation operation control unit 26 performs the separation operation, the foreign-matter removal operation control unit 27 control the transfer-device driver 21 to perform the foreign-matter removal operation. When foreign-matter removal operation control unit 27 performs the foreign-matter removal operation, the foreign-matter removal operation control unit 27 outputs information indicating that the foreign-matter removal operation has been performed to the memory 28.

The memory 28 stores the number of times a high-voltage output abnormality is detected based on information output from the high-voltage output abnormality detection unit 25. The memory 28 also stores information indicating that the foreign-matter removal operation has been performed, based on the information output from the foreign-matter removal operation control unit 27.

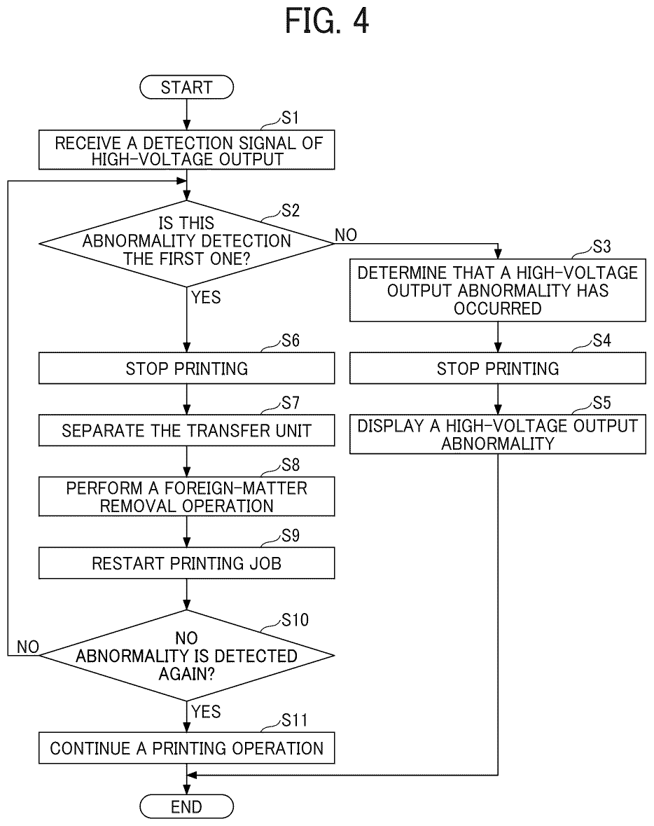

FIG. 4 is a flowchart of a control process for avoiding a high-voltage output abnormality.

The following describes a situation in which a high-voltage output abnormality may occur in the image forming apparatus 100.

The high-voltage output applied to the transfer roller 13 is output from a high-voltage power supply (e.g., the voltage applier 22), passes through a load, including the transfer roller 13 and the transfer belt 5, and returns to ground. At this time, the load has a resistance value within a predetermined range. A constant-voltage (or constant-current) output from the high-voltage power supply supplies a constant current (or a constant voltage) to the load in accordance with the resistance value of the load.

During the printing operation, the high-voltage output is maintained within a predetermined range (a load range) corresponding to a resistance value of a load. If the voltage or the current exceeds the predetermined range, the typical image forming apparatus 100A (see FIG. 1) detects the voltage or the current as a high-voltage abnormality and performs measures such as stopping the printing operation.

An example in which the high-voltage output exceeds a predetermined range is a case in which an overcurrent occurs due to an abnormality in a load. When a conductive foreign object adheres to a high-voltage output path, the conductive foreign object may contact a housing frame (ground) of the image forming apparatus 100 to cause a ground fault, or may come within a short distance of the housing frame (ground) to cause leakage. In this case, an excessive current flows instantaneously, resulting in a high-voltage output abnormality due to overcurrent.

As the conductive foreign matter, metal objects such as a clip or a staple that enter through a gap in a housing of the image forming apparatus are conceivable.

Upon detection of a high-voltage output abnormality, the typical image forming apparatus 100A stops the printing operation and cannot resume printing until inspection or repair is performed by a service person, causing downtime.

However, in the present embodiment, the image forming apparatus 100 automatically performs the foreign-matter removal operation. This allows the high-voltage output abnormality to be automatically cleared, reducing downtime.

High-voltage output abnormality avoidance control will be described below with reference to FIG. 4.

When the controller (specifically, the high-voltage output abnormality detection unit 25) receives a detection signal of a high-voltage output transmitted from the voltage applier 22 (step S1), the controller 24 determines the number of abnormality detections since power-on (step S2). In other words, in step S2, the controller determines whether the abnormality has been detected for the first time. When the controller 24 determines that the abnormality has been detected for the first time (YES in step S2), the process proceeds to step S6 and subsequent steps to perform the foreign-matter removal operation. In step S1, the high-voltage output abnormality detection unit 25 determines whether the voltage applied to the transfer roller 13 is greater than or equal to a predetermined threshold value. In step 2, the controller determines whether a current determination that the voltage is greater than or equal to the predetermined threshold is made for the first time.

In step S6, the separation operation control unit 26 stops the printing operation of the imager 50. Then, in step S7, the separation operation control unit 26 separates the transfer unit 20 from another unit (e.g., the image former 6) that is in contact with the transfer unit 20, isolating the transfer unit 20.

As a result of steps S6 and S7, the sheet is not conveyed and the high voltage is not applied.

Thereafter, in step S8, the foreign-matter removal operation control unit 27 performs a foreign-matter removal operation by rotating the transfer belt 5 of the transfer unit 20 (for example, rotating the transfer belt 5 idly in the forward direction). As a result, if foreign matter is present between the transfer roller 13 and the transfer belt 5 or between the transfer-roller shaft and the housing frame, the foreign matter can be removed.

Also, in the foreign-matter removal operation in step S8, the transfer belt 5 may be rotated idly in the reverse direction. Alternatively or additionally, the separator 23 is controlled to repeatedly separate the transfer unit 20 from and bring the transfer unit 20 into contact with the image former 6, vibrating the transfer unit 20. Thus, the likelihood of removing a foreign matter can be increased.

In step S9, after the idling operation, the controller 24 restarts the printing job that was being performed before the abnormality was detected. This reduces downtime without requiring technician intervention.

When the abnormality is not detected again during printing after the printing job is restarted (YES in step S10), the controller 24 continues printing (step S11). When the printing job is completed during printing after the restart, the controller 24 stops the operation in accordance with the normal sequence and ends this control flow.

When the high-voltage abnormality occurs again during printing after the restart (NO in step S10), the process returns to step S2 and the control flow continues. In this case, because the abnormality is detected for the second time since power-on (NO in step S2), the controller 24 determines that a high-voltage abnormality as occurred (step S3) and stops printing (step S4). Then, instep S5, the controller displays a high-voltage output abnormality message on a display device of the image forming apparatus 100, and requests technician service.

During the processes of steps S3 to S5, in view of a case where foreign matter is not removed by the above-described foreign-matter removal operation, the foreign-matter removal operation control unit 27 records, in the memory 28 of the image forming apparatus 100, a log indicating that the foreign-matter removal operation has been performed.

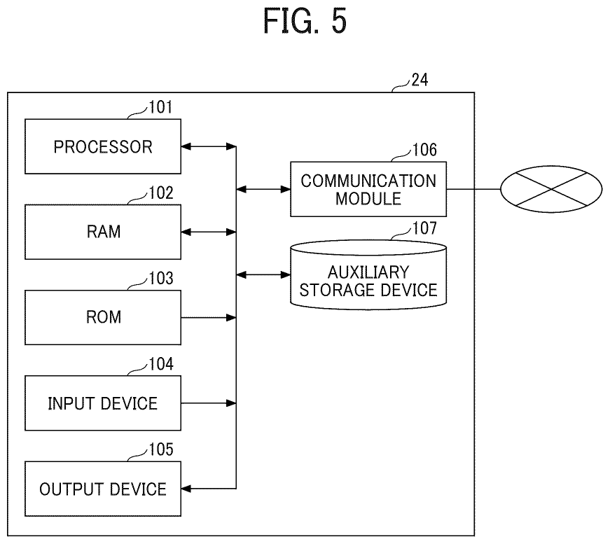

FIG. 5 is a hardware block diagram of a controller 24. As illustrated in FIG. 5, the controller 24 of the imager 50 of the image forming apparatus 100 is physically configured as a computer system including a processor 101 including a Central Processing Unit (CPU) and a Graphics Processing Unit (GPU), a Random Access Memory (RAM) 102 and a Read Only Memory (ROM) 103 as main storage devices, an input device 104 including a keyboard and a mouse, an output device 105 including a display, a communication module 106 including a network card as a data transmitting and receiving device, and an auxiliary storage device 107 including a hard disk. The functions of the controller 24 described above with reference to FIG. 3 are implemented by predetermined computer software. For example, when the computer software is read into the RAM 102 and executed by the CPU 101, the CPU 101 controls the communication module 106, the input device 104, and the output device 105, and reads and writes data from and to the RAM 102 and the auxiliary storage device 107.

As described above, the image forming apparatus 100 according to the present embodiment includes an image former 6 that forms a toner image; a transfer unit 20 including a transfer belt 5 and a transfer roller 13, the transfer unit 20 transferring the toner image onto the transfer belt 5 by the transfer roller 13; a voltage applier 22 that applies a voltage to the transfer roller 13; a transfer-device driver 21 that drives the transfer belt 5; a separator 23 that separates the transfer unit 20 from the image former 6; and a controller 24 that, when detecting a high-voltage output abnormality from the voltage applier 22, causes the separator 23 to separate the transfer unit 20 from the image former 6 and causes the transfer-device driver 21 to perform a foreign-matter removal operation in which the transfer belt 5 is rotated in a forward direction or a reverse direction.

This configuration allows, when an overcurrent caused by entry of a foreign matter into the transfer unit 20 is detected, the foreign-matter removal operation to be automatically executed to remove the foreign matter. This eliminates the need to perform an inspection operation by a serviceman each time an abnormality occurs, thus reducing downtime when an overcurrent caused by entry of a foreign matter into the transfer unit 20 is detected.

An image forming apparatus (100) includes an image former (6) to form a toner image, a voltage applier (22), a transfer-device driver (21), a separator (23), and circuitry (e.g., the controller 24). The transfer device (20) includes a transfer belt (5) and a transfer roller (13) facing the image former (6) with the transfer belt (5) between the transfer roller (13) and the image former (6), to transfer the toner image from the image former onto the transfer belt (5) using the transfer roller. The voltage applier (22) applies a voltage to the transfer roller (13). The transfer-device driver (21) drives the transfer belt (5) to rotate. The separator (23) separates the transfer device (20) from the image former (6). The circuitry is configured to determine whether the voltage applied to the transfer roller is greater than or equal to a predetermined threshold. The circuitry is further configured to, in response to a determination that the voltage is greater than or equal to the threshold value, control the separator (23) to separate the transfer device (20) from the image former (6); and control the transfer-device driver (21) to drive the transfer belt (5) to rotate in a forward direction or a backward direction to perform a foreign-matter removal operation.

The circuitry is further configured to control the separator (23) to repeatedly separate the transfer device (20) from the image former (6) and bring the transfer device (20) into contact with the image former (6), to vibrate the transfer device (20) to perform the foreign-matter removal operation.

The image forming apparatus further includes a memory that stores a number of determinations that the voltage is greater than or equal to the predetermined threshold; and information indicating that the foreign-matter removal operation has been performed.

The circuitry is further configured to determine whether a current determination that the voltage is greater than or equal to the predetermined threshold is made for a first time; in response to a determination that the current determination is made for the first time, perform the foreign-matter removal operation; and restart forming the toner image by the image former.

The embodiments of the present disclosure are described above with reference to specific examples. However, the present disclosure is not limited to the above-described specific examples. These specific examples to which appropriate design modifications are added by those skilled in the art are also included in the scope of the present disclosure as long as the features of the present disclosure are included. Each element included in each specific example described above and the arrangement, condition, shape, and the like thereof are not limited to those illustrated and may be changed as appropriate. The elements included in the specific examples described above may be combined as appropriate as long as there is no technical contradiction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image former to form a toner image;
a transfer device including:
a transfer belt; and
a transfer roller facing the image former with the transfer belt between the transfer roller and the image former,
to transfer the toner image from the image former onto the transfer belt using the transfer roller; and
a voltage applier to apply a voltage to the transfer roller;
a separator to separate the transfer device from the image former; and
circuitry configured to:
determine whether the voltage applied to the transfer roller is greater than or equal to a predetermined threshold; and
in response to a determination that the voltage is greater than or equal to the threshold value:
control the separator to separate the transfer device from the image former; and
drive the transfer belt to rotate in a forward direction or a backward direction to perform a foreign-matter removal operation.

2. The image forming apparatus according to claim 1, wherein:
the circuitry is further configured to:
control the separator to repeatedly:
separate the transfer device from the image former; and
bring the transfer device into contact with the image former,
to vibrate the transfer device to perform the foreign-matter removal operation.

3. The image forming apparatus according to claim 1, further comprising a memory that stores:
a number of determinations that the voltage is greater than or equal to the predetermined threshold; and
information indicating that the foreign-matter removal operation has been performed.

4. The image forming apparatus according to claim 3, wherein:
the circuitry is further configured to:
determine whether a current determination that the voltage is greater than or equal to the predetermined threshold is made for a first time; and
in response to a determination that the current determination is made for the first time,
perform the foreign-matter removal operation; and
restart forming the toner image by the image former.
